(19) United States
(12) Patent Application Publication
(10) Pub. No.: US 2007/0227032 A1
(43) Pub. Date: Oct. 4, 2007

(54) SUBSTRATE PROCESSING APPARATUS

(76) Inventor: Masahiro KIMURA, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/693,429

(22) Filed: Mar. 29, 2007

(30) Foreign Application Priority Data
Mar. 31, 2006 (JP) JP2006-098132

(51) Int. Cl. F26B 3/00

(52) U.S. Cl. 34/351; 34/340

(57) ABSTRACT

A discharge pipe is provided within a processing chamber, and ejects a drying gas. A pressure reducing pump exhausts air from the processing chamber to create a reduced-pressure atmosphere in the processing chamber. A drying gas supply passage supplies the drying gas generated in a first drying gas generator and in a second drying gas generator to the discharge pipe. The first drying gas generator generates the drying gas by bubbling IPA liquid stored in a heating bath with nitrogen gas. The second drying gas generator generates the drying gas by mixing IPA vapor produced by evaporation in an IPA vapor generating bath and nitrogen gas together. Thus, the supply of the drying gas generated in the plurality of drying gas generators to the processing chamber increases the concentration of the IPA vapor within the processing chamber. This shortens the time required for drying to improve drying performance.

### BACKGROUND OF THE INVENTION

1. Field of the Invention

The present invention relates to a substrate processing apparatus for processing a substrate including a semiconductor substrate, a glass substrate for a liquid crystal display device, a glass substrate for a photomask, a substrate for an optical disk, and the like. More particularly, the present invention relates to an improvement in a drying process for execution upon a substrate subjected to a rinsing process using deionized water.

2. Description of the Background Art

A substrate processing apparatus has heretofore been known which performs a drying process on a substrate by supplying an organic solvent vapor such as isopropyl alcohol (referred to hereinafter as IPA) vapor to around the substrate while pulling up the substrate out of deionized water after performing a process using a liquid chemical such as hydrofluoric acid (HF) and a rinsing process using deionized water sequentially in substrate manufacturing steps. This substrate processing apparatus is capable of efficiently drying a substrate by reducing the pressure of an atmosphere in a processing chamber after substituting the IPA vapor for water or moisture adhering to the surface of the substrate.

With demands for the smaller size, lower weight, higher speed and higher functionality of electronic equipment, there has been a requirement for the reduction in size and the increase in density of patterns on the surfaces of substrates. As an example, a hole structure formed on the surface of a substrate has an increasing aspect ratio that is the ratio of a hole depth to a hole width.

Under such circumstances, the entry of deionized water into the interior of the hole structure under conditions of low IPA concentration deteriorates the performance of the substitution of the IPA vapor for the deionized water having entered the interior of the hole structure. As a result, the conventional substrate processing apparatus presents a problem such that the increase in the amount of drying time deteriorates drying performance.

### SUMMARY OF THE INVENTION

The present invention is intended for a substrate processing apparatus for performing a drying process on a substrate.

According to the present invention, the substrate processing apparatus comprises: a processing chamber for receiving a substrate therein; a drying gas supply part provided within the processing chamber for supplying a drying gas into the processing chamber; a first generator for generating the drying gas; a second generator for generating the drying gas; a carrier gas supply passage for supplying a carrier gas to the first generator and the second generator; and a drying gas supply passage for supplying the drying gas generated in the first generator and the drying gas generated in the second generator to the drying gas supply part. The first generator includes a first reservoir for storing a drying liquid therein, a heating part for heating the drying liquid stored in the first reservoir, and a first carrier gas inlet passage connected to the carrier gas supply passage for introducing the carrier gas supplied from the carrier gas supply passage into the drying liquid stored in the first reservoir. The first generator mixes the carrier gas introduced from the first carrier gas inlet passage and a vapor of drying liquid produced in the first reservoir together to generate the drying gas. The second generator includes a second reservoir for storing the drying liquid therein, a gas mixing chamber for housing the second reservoir, an intake part for guiding the drying liquid heated in the first reservoir into the second reservoir, and a second carrier gas inlet passage connected to the carrier gas supply passage for introducing the carrier gas supplied from the carrier gas supply passage into the gas mixing chamber. The second generator mixes the carrier gas introduced from the second carrier gas inlet passage and a vapor of drying liquid produced in the second reservoir together to generate the drying gas.

The substrate processing apparatus shortens the time required for drying of the substrate to improve substrate drying performance.

Preferably, the substrate processing apparatus further comprises: a switching valve provided in the first carrier gas inlet passage; and a controller for controlling the opening and closing operation of the switching valve to control the amount of carrier gas supplied to the first reservoir.

The substrate processing apparatus is capable of controlling the concentration of the drying gas within the processing chamber in accordance with the condition of the substrate to be dried.

Preferably, the controller controls the opening and closing operation of the switching valve in accordance with a device structure formed on a surface of the substrate.

The substrate processing apparatus is capable of performing the drying process in accordance with the device structure formed on the surface of the substrate.

It is therefore an object of the present invention to provide a substrate processing apparatus capable of performing a good drying process upon a substrate.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing an example of the overall construction of a substrate processing apparatus according to a preferred embodiment of the present invention;

FIG. 2 conceptually shows the overall construction of a reduced-pressure drying part;

FIG. 3 is a front view, with portions of external construction broken away, of a pair of drying gas generators;

FIG. 4 illustrates a relationship between IPA consumption and the opening/closing of a switching valve, and a relationship between an IPA vapor concentration and the opening/closing of the switching valve; and

FIG. 5 is a flow diagram for illustrating a technique for determining whether to open or close the switching valve.

### DESCRIPTION OF THE PREFERRED EMBODIMENTS

A preferred embodiment according to the present invention will now be described in detail with reference to the drawings.

<1. Construction of Wet Station>

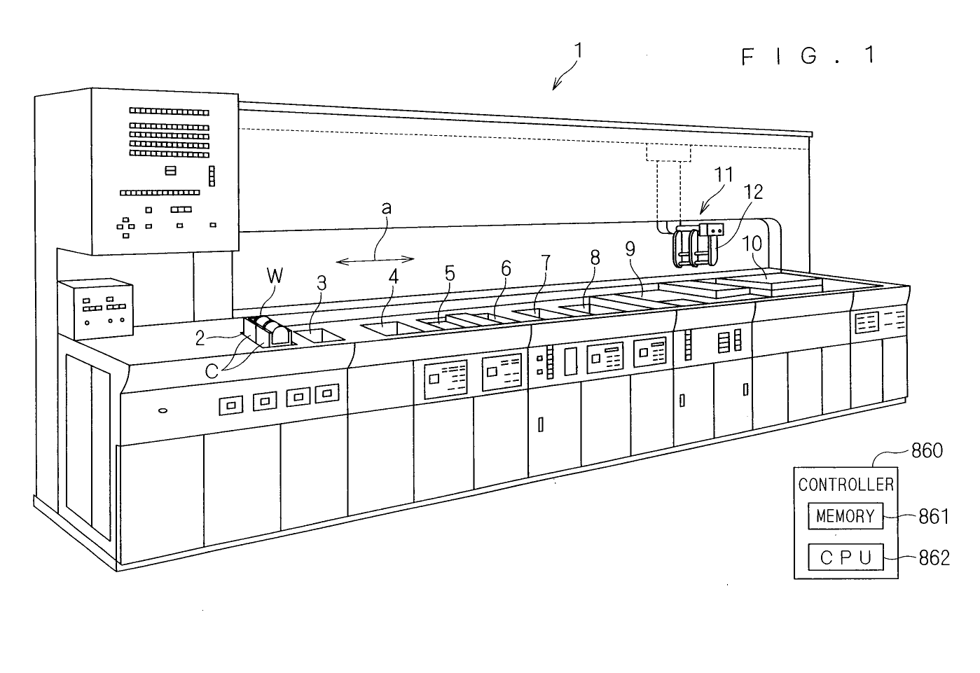

FIG. 1 is a perspective view showing an example of the overall construction of a wet station 1 according to a preferred embodiment of the present invention. This wet station 1 is a substrate processing apparatus of a “batch type” which performs substrate processing upon a plurality of substrates W at a time. A plurality of (e.g., 26) substrates W held in a cassette C are subjected to a cleaning process using a liquid chemical, a rinsing process using deionized water, and a drying process.

As shown in FIG. 1, the wet station 1 principally includes an alignment part 2, an extraction part 3, processing parts 4 to 9, a reduced-pressure drying part 10, and a transport robot 11. In this preferred embodiment, the alignment part 2, the extraction part 3, the processing parts 4 to 9, and the reduced-pressure drying part 10 are arranged linearly in a predetermined direction AR1, as shown in FIG. 1.

The alignment part 2 brings substrates W (e.g., 52 substrates W) for two cassettes into proper orientation. The extraction part 3 collectively removes the substrates W brought into proper orientation by the alignment part 2 out of a cassette C. The processing parts 4 to 9 perform a process using a liquid chemical or deionized water upon the substrates W removed out of the cassette C by the extraction part 3. Each of the processing parts 4 to 9 includes a processing bath (not shown) disposed therein and capable of storing therein a liquid chemical including, for example, ammonia (NH₃), hydrofluoric acid (HF), sulfuric acid (H₂SO₄) and the like, or deionized water. Thus, when the substrates W are collectively immersed in the chemical solution or deionized water stored in such a processing bath, the surfaces of the substrates W are cleaned, and particles and the like are removed from the surfaces of the substrates W.

The reduced-pressure drying part 10 collectively rinses a plurality of substrates W with deionized water, and dries the plurality of substrates W under a reduced pressure. The details of the reduced-pressure drying part 10 will be described later.

The transport robot 11 is provided over the extraction part 3, the processing parts 4 to 9 and the reduced-pressure drying part 10, and is movable in the predetermined direction AR1, as shown in FIG. 1. The transport robot 11 includes a holding chuck 12 for collectively holding a plurality of substrates W. This holding chuck 12 is openable and closable in the predetermined direction AR1, and is movable up and down relative to the transport robot 11.

Thus, the transport robot 11 is capable of moving downwardly into the interiors of the processing parts 4 to 9 and the reduced-pressure drying part 10 to transfer and receive a plurality of substrates W to and from the processing parts 4 to 9 and the reduced-pressure drying part 10, and is capable of transporting a plurality of substrates W collectively between the extraction part 3 and the reduced-pressure drying part 10.

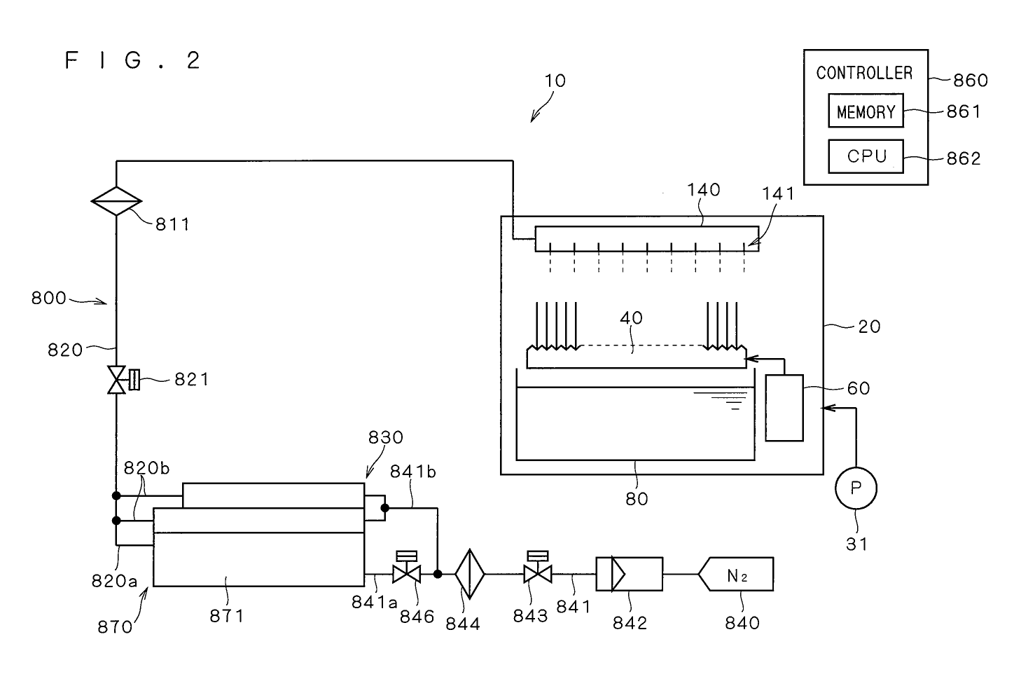

A controller 860 includes a memory 861 for storing therein a program, variables and the like, and a CPU 862 for effecting control in accordance with the program stored in the memory 861. In accordance with the program stored in the memory 861, the CPU 862 thus controls the opening and closing of a drying gas supply valve 821, a nitrogen gas supply valve 843 and a switching valve 846 (see FIG. 2), the exhaust of air by using a pressure reducing pump 31 (see FIG. 2), the upward and downward movement of a guide 40 (see FIG. 2) by using a driving mechanism 60, and the like in predetermined timed relation.

<2. Construction of Reduced-Pressure Drying Part>

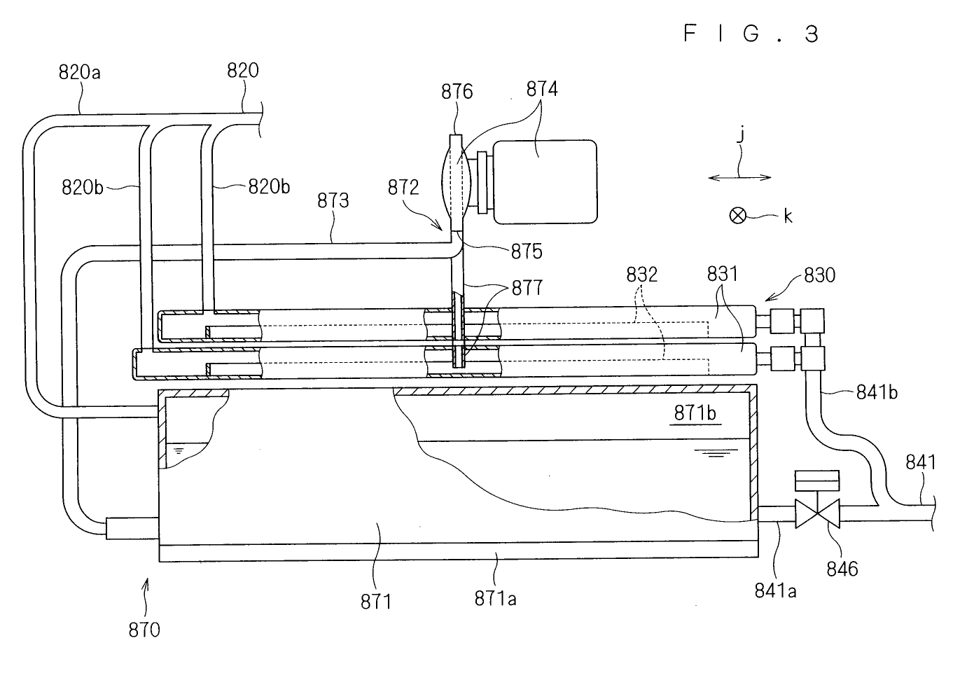

FIG. 2 conceptually shows the overall construction of the reduced-pressure drying part 10. FIG. 3 is a front view, with portions of external construction broken away, of a first drying gas generator 870 and a second drying gas generator 830. The reduced-pressure drying part 10 rinses the substrates W with deionized water, and dries the substrates W by using a gas (referred to hereinafter as a “drying gas”) including IPA vapor. As shown in FIG. 2, the reduced-pressure drying part 10 principally includes a processing chamber 20, the guide 40, a processing bath 80, a discharge pipe 140, the pressure reducing pump 31, and a drying gas supply mechanism 800.

The guide 40 is provided within the processing chamber 20, and holds a plurality of substrates W in an upright position. The guide 40 is movable up and down by the driving mechanism 60. Thus, the driving mechanism 60 drives the guide 40 to move the guide 40 upwardly and downwardly between a transfer position in which the guide 40 transfers and receives the substrates W to and from the transport robot 11 and a rinsing position in which the substrates W are immersed in the deionized water stored in the processing bath 80. The processing bath 80 is provided within the processing chamber 20, and is capable of storing deionized water therein. The substrates W are rinsed by being immersed in the deionized water stored in the processing bath 80.

The discharge pipe 140 is provided within the processing chamber 20, and serves as a drying gas supply part for ejecting the drying gas (a mixture of IPA vapor and nitrogen gas) toward the interior of the processing chamber 20. The discharge pipe 140 is an elongated pipe made of a resin such as PFA (Tetrafluoroethylene-perfluoroalkylvinylether copolymer), and has a plurality of discharge openings 141 for ejecting the drying gas.

Ejecting the drying gas from the discharge pipe 140 into the processing chamber 20 while moving the substrates W subjected to the rinsing process using the deionized water upwardly out of the processing bath 80 causes the substitution of the IPA vapor included in the drying gas for droplets of deionized water adhering to the surfaces of the substrates W. Thus, the droplets of deionized water are removed from the surfaces of the substrates W, and the surfaces of the substrates W are covered with the IPA vapor.

The pressure reducing pump 31 serves as a pressure reducing part for exhausting air from the processing chamber 20 to create a reduced-pressure atmosphere in the processing chamber 20. When the pressure in the processing chamber 20 is reduced with the surfaces of the substrates W covered with the IPA vapor, IPA liquid on the surfaces of the substrates W is evaporated, and the surfaces of the substrates W are dried.

The drying gas supply mechanism 800 is a mechanism for supplying the drying gas into the processing chamber 20. As shown in FIG. 2, the drying gas supply mechanism 800 principally includes a drying gas supply passage 820, the first drying gas generator 870, and the second drying gas generator 830.

The drying gas supply passage 820 supplies the drying gas generated in the first drying gas generator 870 and in the second drying gas generator 830 to the discharge pipe 140. As shown in FIG. 2, the drying gas supply passage 820 has a first end connected to the discharge pipe 140, and a second end connected to a first drying gas inlet passage 820a and to a plurality of (in this preferred embodiment, two) second drying gas inlet passages 820b.

As shown in FIG. 2, the drying gas supply valve 821, and a filter 811 for removing extraneous matter such as particles from the drying gas are disposed in the drying gas supply passage 820 in the order named as viewed in a downstream direction from the first drying gas generator 870 and the second drying gas generator 830 toward the discharge pipe 140. The ejection of the drying gas from the discharge pipe 140 is controlled by controlling the opening and closing of the drying gas supply valve 821.

As illustrated in FIG. 3, the first drying gas generator 870 principally includes a heating bath (a first reservoir) 871, a heater 871a, and a first nitrogen gas inlet passage 841a for introducing the nitrogen gas (carrier gas) into the heating bath 871.

The heating bath 871 is capable of storing the IPA liquid for use as a drying liquid therein. The heater 871a is a heater for heating the IPA liquid stored in the heating bath 871, and is provided near the bottom of the heating bath 871, as shown in FIG. 3.

In this preferred embodiment, the IPA liquid stored in the heating bath 871 is heated up to a temperature T0 (60 to 80° C.) or higher. Thus, part of the IPA liquid stored in the heating bath 871 changes into vapor which is present in the interior space 871b of the heating bath 871.

The first nitrogen gas inlet passage 841a introduces the nitrogen gas into the IPA liquid stored in the heating bath 871. As shown in FIG. 3, the first nitrogen gas inlet passage 841a has a first end connected to the interior of the heating bath 871, and a second end connected to a nitrogen gas supply passage 841. As shown in FIG. 2, a flow meter 842 for detecting the amount of supply of the nitrogen gas, the nitrogen gas supply valve 843, and a filter 844 for removing extraneous matter such as particles from the nitrogen gas are disposed in the nitrogen gas supply passage 841 in the order named as viewed in a downstream direction from a nitrogen gas supply source 840 toward the heating bath 871. The switching valve 846 is inserted in the first nitrogen gas inlet passage 841a.

When the nitrogen gas supply valve 843 and the switching valve 846 are opened, the nitrogen gas supplied from the nitrogen gas supply source 840 is introduced into the heating bath 871 so that the IPA vapor is produced by bubbling. The IPA vapor produced by bubbling, the IPA vapor produced by evaporation of the IPA liquid stored in the heating bath 871, and the nitrogen gas introduced from the first nitrogen gas inlet passage 841a are mixed together in the interior space 871b of the heating bath 871 to generate the drying gas. Specifically, the controller 860 controls the opening and closing operations of the nitrogen gas supply valve 843 and the switching valve 846 to control the supply of the nitrogen gas to the heating bath 871, thereby controlling the generation of the drying gas in the first drying gas generator 870.

The drying gas generated in the interior space 871b moves with a flow of nitrogen gas introduced from the first nitrogen gas inlet passage 841a, and is supplied through the first drying gas inlet passage 820a to the drying gas supply passage 820. The IPA liquid stored in the heating bath 871 is heated up to the temperature TO (60 to 80° C.) or higher, and the generated drying gas is at a relatively high temperature.

As illustrated in FIG. 3, the second drying gas generator 830 principally includes a plurality of (in this preferred embodiment, two) gas mixing chambers 831, a plurality of IPA vapor generating baths (a second reservoir) 832 provided in the respective gas mixing chambers 831, an IPA intake part 872, and a second nitrogen gas inlet passage 841b in communication with the interior of each of the gas mixing chambers 831.

The IPA intake part 872 guides the IPA liquid stored in the heating bath 871 into each of the IPA vapor generating baths 832. As shown in FIG. 3, the IPA intake part 872 principally includes an IPA pumping part 873, a bellows pump 874, a suction port 875, a discharge port 876, and an IPA distributing passage 877.

The IPA pumping part 873 extends upwardly of the heating bath 871, and has a first end connected to the interior of the heating bath 871 and a second end connected to the suction port 875 of the bellows pump 874. The IPA distributing passage 877 is disposed so as to hide behind the bellows pump 874 when viewed from the front, and extends downwardly. As shown in FIG. 3, the IPA distributing passage 877 has a first end connected to the discharge port 876 of the bellows pump 874, and a second end divided into a plurality of (in this preferred embodiment, two) branches. The branches of the second end of the IPA distributing passage 877 reach the corresponding IPA vapor generating baths 832.

Thus, when the bellows pump 874 is driven, the IPA liquid stored in the heating bath 871 is sucked through the IPA pumping part 873 into the bellows pump 874. The IPA liquid sucked in the bellows pump 874 is supplied through the discharge port 876 and the IPA distributing passage 877 to the IPA vapor generating baths 832. The IPA liquid supplied to the IPA vapor generating baths 832 is evaporated in the IPA vapor generating baths 832 to change into IPA vapor.

The second nitrogen gas inlet passage 841b introduces the nitrogen gas into the gas mixing chambers 831. As shown in FIG. 2, the second nitrogen gas inlet passage 841b has a first end connected to the interior of each of the gas mixing chambers 831, and a second end connected to the nitrogen gas supply passage 841.

Thus, when the nitrogen gas supply valve 843 is opened, the nitrogen gas is introduced from the nitrogen gas supply source 840 through the nitrogen gas supply passage 841 and the second nitrogen gas inlet passage 841b into the gas mixing chambers 831. The nitrogen gas introduced into the gas mixing chambers 831 and the vapor of the IPA liquid generated in the IPA vapor generating baths 832 are mixed together in the gas mixing chambers 831 to generate the drying gas.

The drying gas generated in each of the gas mixing chambers 831 moves with a flow of nitrogen gas introduced from the second nitrogen gas inlet passage 841b, and is supplied through a corresponding one of the second drying gas inlet passages 820b to the drying gas supply passage 820. The IPA liquid supplied from the heating bath 871 to the IPA vapor generating baths 832 is heated up to the temperature T0 (60 to 80° C.) or higher, and the generated drying gas is at a relatively high temperature.

<3. Relationship Between IPA Consumption and Opening/Closing Operation of Switching Valve, and Relationship Between IPA Vapor Concentration and Opening/Closing Operation of Switching Valve>

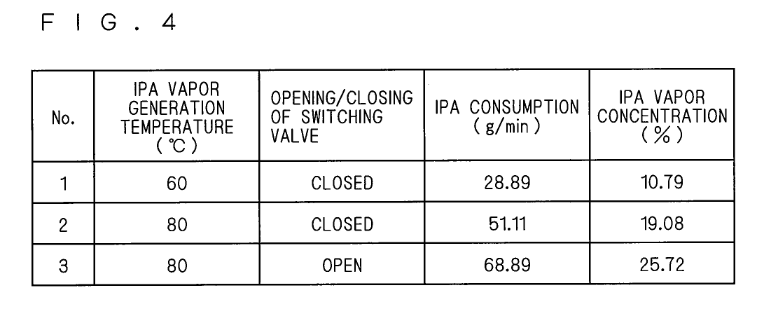

FIG. 4 illustrates a relationship between IPA consumption and the opening/closing operation of the switching valve 846, and a relationship between an IPA vapor concentration and the opening/closing operation of the switching valve 846. The IPA consumption and the IPA vapor concentration are used herein as indicators for comparison between a drying process in which the drying gas is generated only in the second drying gas generator 830 and a drying process in which the drying gas is generated in the first drying gas generator 870 and in the second drying gas generator 830.

The term “IPA vapor generation temperature” (in ° C.) used herein refers to the temperature of the IPA liquid for use in the generation of the IPA vapor, and also refers to the temperature of the IPA liquid stored in the heating bath 871. The term “IPA consumption” (in g/min.) used herein refers to the amount of IPA consumed per unit time when the drying processes using the drying gas are performed on substrates W in the processing chamber 20. The term “IPA vapor concentration” (in %) used herein refers to the concentration of the IPA vapor in the atmosphere in the processing chamber 20. When these drying processes are performed, both the drying gas supply valve 821 and the nitrogen gas supply valve 843 are open.

When the switching valve 846 is closed (in the instances indicated by Nos. 1 and 2 in FIG. 4), the nitrogen gas from the nitrogen gas supply source 840 is supplied to the second drying gas generator 830, whereby the drying gas is generated in the second drying gas generator 830. Under such conditions, the higher the IPA vapor generation temperature is (as in the instance indicated by No. 2), the higher the IPA consumption and the IPA vapor concentration are.

When the switching valve 846 is open (in the instance indicated by No. 3 in FIG. 4), the nitrogen gas from the nitrogen gas supply source 840 is supplied to both the first drying gas generator 870 and the second drying gas generator 830, whereby the drying gas is generated in both the first drying gas generator 870 and the second drying gas generator 830. The IPA consumption and the IPA vapor concentration in this instance are higher than those in the instance indicated by No. 2 in FIG. 4 where the IPA vapor generation temperature is equal but the switching valve 846 is closed.

In this preferred embodiment, as described above, when the drying gas supply valve 821, the nitrogen gas supply valve 843 and the switching valve 846 are opened, the drying gas is generated in both the first drying gas generator 870 and the second drying gas generator 830, whereby the amount of IPA consumed in the processing chamber 20 increases and the IPA vapor concentration in the processing chamber 20 increases. This improves the rate of substitution of the IPA vapor for droplets of deionized water on the substrates W to shorten the time required for drying of the substrates W.

Also, if a trench having a high aspect ratio, for example, is formed in the substrates W, this preferred embodiment is capable of satisfactorily substituting the IPA vapor for the deionized water entering the trench to improve substitution performance. Thus, if patterns formed on the substrates W become finer and denser, this preferred embodiment suppresses the occurrence of water marks (drying failure resulting from the reaction of water, oxygen and silicon in the substrates) to improve drying performance.

A procedure for the drying process in the reduced-pressure drying part 10 will be described. Prior to the start of the drying process, the substrates W are immersed in and rinsed with the deionized water stored in the processing bath 80.

After the completion of the rinsing process of the substrates W, the nitrogen gas is supplied into the processing chamber 20 to decrease the concentration of oxygen in the processing chamber 20. Subsequently, the drying gas supply valve 821, the nitrogen gas supply valve 843 and the switching valve 846 are opened to supply the drying gas generated in both the first drying gas generator 870 and the second drying gas generator 830 into the processing chamber 20. This creates an atmosphere containing IPA vapor within the processing chamber 20.

After a lapse of predetermined time since the start of the supply of the drying gas into the processing chamber 20, the guide 40 which holds the plurality of substrates W is moved upwardly from the processing bath 80 by the driving mechanism 60 to pull up the substrates W out of the deionized water stored in the processing bath 80. While the substrates W are pulled up, the IPA vapor in the processing chamber 20 is substituted for droplets adhering to the surfaces of the substrates W, and the surfaces of the substrates W are covered with IPA.

Thereafter, when the pressure reducing pump 31 is driven to reduce the pressure of the atmosphere in the processing chamber 20, the IPA covering the surfaces of the substrates W is evaporated, and the surfaces of the substrates W are dried. After the completion of the drying process, the pressure of the atmosphere in the processing chamber 20 is changed back to atmospheric pressure.

<4. Relationship Between Opening/Closing Operation of Switching Valve and Device Structure>

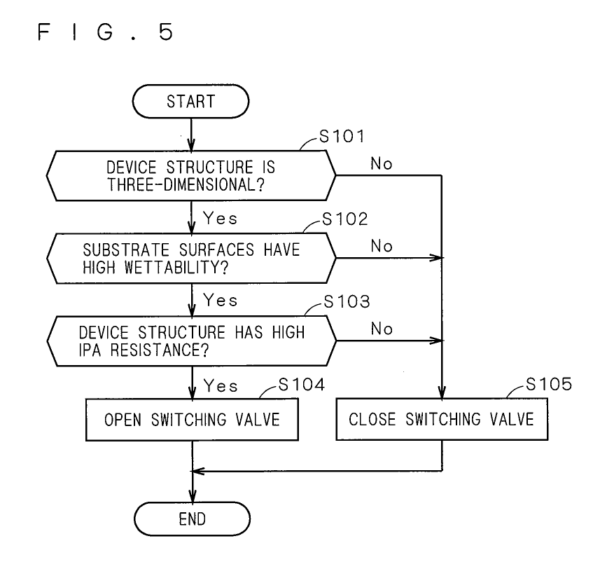

FIG. 5 is a flow diagram for illustrating a technique for determining whether to open or close the switching valve 846. In this preferred embodiment, a device structure formed on the substrates W is judged, and whether to open or close the switching valve 846 is controlled in accordance with the device structure, based on the result of the judgment.

The concept of the device structure in this preferred embodiment includes not only the three-dimensional structure of patterns formed on the substrates W but also the material forming the patterns and the physical properties and the like of the material. Whether to open or close the switching valve 846 may be judged by a user of the wet station 1 in accordance with steps to be described below or be judged by the controller 860 based on data (numerical data) into which information about the device structure is previously converted.

The first step in the technique for determining whether to open or close the switching valve 846 is to judge whether the device structure of the substrates W to be dried is a three-dimensional structure or not (in Step S101). For example, when trenches having a high aspect ratio are formed in the substrates W to involve the need for increase in the performance of the substitution of the IPA vapor for the droplets of deionized water, the processing proceeds to Step S102.

The processing proceeds to Step S105, on the other hand, when the performance of the substitution of the IPA vapor for the droplets of deionized water is maintained without the need to increase the concentration of the IPA vapor in the processing chamber 20, such as when the patterns formed on the substrates W are planar.

Next, the wettability of the surfaces of the substrates W to be dried is judged (in Step S102). For example, when the surfaces of the substrates W to be dried are formed entirely or partially of a hydrophilic material so that the surfaces of the substrates W have a portion with high wettability, it is necessary to increase the performance of the substitution of the IPA vapor for the droplets of deionized water, and the processing therefore proceeds to Step S103. The processing proceeds to Step S105, on the other hand, when the entire surfaces of the substrates W are formed of a hydrophobic material.

Subsequently, a judgment is made as to whether the device structure of the substrates W to be dried has IPA resistance or not (in Step S103). The IPA resistance refers to the resistance of the device structure to IPA, and includes resistance to corrosion and the like by IPA. The processing proceeds to Step S104 when the device structure has high IPA resistance. The processing, on the other hand, proceeds to Step S105 when the device structure has low IPA resistance.

The controller 860 opens the switching valve 846 to supply the nitrogen gas through the first and second nitrogen gas inlet passage 841a and 841b (in Step S104) when all of the following conditions are satisfied: the device structure is three-dimensional (in Step S101); the surfaces of the substrates W have high wettability (in Step S102); and the device structure has high IPA resistance (in Step S103). Thus, both the first drying gas generator 870 and the second drying gas generator 830 generate the drying gas, to make the concentration of the IPA vapor within the processing chamber 20 higher.

The controller 860, on the other hand, closes the switching valve 846 to supply the nitrogen gas through only the second nitrogen gas inlet passage 841b (in Step S105) when not all of the conditions in Steps S101 to S103 are satisfied, that is, when it is not necessary to increase the concentration of the IPA vapor within the processing chamber 20 in the drying process. Thus, only the second drying gas generator 830 generates the drying gas. This lowers the concentration of the IPA vapor within the processing chamber 20 depending on the device structure to reduce the amount of IPA usage in this preferred embodiment.

<5. Advantages of Wet Station in Preferred Embodiment>

As described hereinabove, the wet station 1 according to the preferred embodiment is capable of generating the drying gas in both the first drying gas generator 870 and the second drying gas generator 830 by opening the drying gas supply valve 821, the nitrogen gas supply valve 843 and the switching valve 846. This increases the amount of IPA consumed within the processing chamber 20 to increase the concentration of the IPA vapor within the processing chamber 20. Therefore, the wet station 1 improves the rate of the substitution of the IPA vapor for the droplets of deionized water on the substrates W to shorten the time required for drying of the substrates W.

In addition, if a trench having a high aspect ratio, for example, is formed in the substrates W, the wet station 1 according to this preferred embodiment is capable of satisfactorily substituting the IPA vapor for the deionized water entering the trench to improve the substitution performance. Thus, if patterns formed on the substrates W become finer and denser, the wet station 1 according to this preferred embodiment suppresses the occurrence of water marks (drying failure resulting from the reaction of water, oxygen and silicon in the substrates) to improve the drying performance.

<6. Modifications>

The preferred embodiment according to the present invention has been described hereinabove. The present invention, however, is not limited to the above-mentioned preferred embodiment, but various modifications may be made therein.

The IPA liquid is used as the drying liquid in this preferred embodiment. The drying liquid, however, is not limited to this, but may be, for example, a hydrophilic, water-soluble organic solvent. More specifically, the drying liquid may include ketones (acetone, diethyl ketone and the like), ethers (methyl ether, ethyl ether and the like), and polyhydric alcohols (ethylene glycol and the like). However, the IPA liquid is most preferably used as the drying liquid as in this preferred embodiment in the light of the fact that a large number of drying liquids with a low content of impurities such as metal are introduced on the market.

For the judgment about the device structure formed on the substrates W according to this preferred embodiment, the following three judgments are made in the order named: the judgment as to whether the device structure is three-dimensional or not (in Step S101); the judgment as to the wettability of the surfaces of the substrates W (in Step S102); and the judgment as to the resistance of the device structure to IPA (in Step S103). The order in which these judgments are made is not limited to this. Other orders (five orders in total) than the order shown in FIG. 5 may be selected.

The nitrogen gas is used as the carrier gas in the above description according to the preferred embodiment. The carrier gas, however, is not limited to this. The carrier gas is required only to be inert to, for example, the substrates W and the drying liquid, and may include argon gas and helium gas as well as the nitrogen gas.

While the invention has been described in detail, the foregoing description is in all aspects illustrative and not restrictive. It is understood that numerous other modifications and variations can be devised without departing from the scope of the invention.

What is claimed is:

1. A substrate processing apparatus for performing a drying process on a substrate, comprising:
a processing chamber for receiving a substrate therein;
a drying gas supply part provided within said processing chamber for supplying a drying gas into said processing chamber;
a first generator for generating the drying gas;
a second generator for generating the drying gas;
a carrier gas supply passage for supplying a carrier gas to said first generator and said second generator; and
a drying gas supply passage for supplying the drying gas generated in said first generator and the drying gas generated in said second generator to said drying gas supply part,
said first generator including
a first reservoir for storing a drying liquid therein,
a heating part for heating the drying liquid stored in said first reservoir, and
a first carrier gas inlet passage connected to said carrier gas supply passage for introducing the carrier gas supplied from said carrier gas supply passage into the drying liquid stored in said first reservoir,
said first generator mixing the carrier gas introduced from said first carrier gas inlet passage and a vapor of drying liquid produced in said first reservoir together to generate the drying gas,
said second generator including
a second reservoir for storing the drying liquid therein,
a gas mixing chamber for housing said second reservoir,
an intake part for guiding the drying liquid heated in said first reservoir into said second reservoir, and
a second carrier gas inlet passage connected to said carrier gas supply passage for introducing the carrier gas supplied from said carrier gas supply passage into said gas mixing chamber,
said second generator mixing the carrier gas introduced from said second carrier gas inlet passage and a vapor of drying liquid produced in said second reservoir together to generate the drying gas.

2. The substrate processing apparatus according to claim 1, further comprising:
a switching valve provided in said first carrier gas inlet passage; and
a controller for controlling the opening and closing operation of said switching valve to control the amount of carrier gas supplied to said first reservoir.

3. The substrate processing apparatus according to claim 2, wherein
said controller controls the opening and closing operation of said switching valve in accordance with a device structure formed on a surface of the substrate.
